(19) United States
(12) Patent Application Publication
(10) Pub. No.: US 2007/0182037 A1
(43) Pub. Date: Aug. 9, 2007

(54) Preparation of transparent ceramics of yag dope by lanthanides

(76) Inventors: Yoel Rabinovitch, Rambouillet (FR); Fabienne Karolak, Fresnes (FR); Christine Bogicevic, Meudon (FR); Daniel Tetard, Ambazac (FR); Hichem ben Habib Dammak, Antony (FR)

Correspondence Address: YOUNG & THOMPSON, 745 SOUTH 23RD STREET, 2ND FLOOR, ARLINGTON, VA, 22202, US

(21) Appl. No.: 11/547,780

(22) PCT Filed: Apr. 6, 2005
(86) PCT No.: PCT/FR05/00844

§ 371 Date: Mar. 15, 2007

(30) Foreign Application Priority Data
Apr. 7, 2004 (FR) 0403668

(51) Int. Cl. B29D 11/00; B29B 9/00

(52) U.S. Cl. 264/1.1; 264/5; 264/681

(57) ABSTRACT

The invention relates to a method for preparing a transparent ceramic material based on an intermetallic oxide, comprising the following steps: (A) particles (p) based on said intermetallic oxide are synthesised by oxidising calcination of particles (p0) containing a homogeneous mixture of organic salts of different metallic cations of the intermetallic oxide; (B) a moulded material (M) is produced from the particles (p) obtained in this way, using a filtering pressing technique; and (C) the moulded material (M) is thermally processed (sintered). The invention also relates to the materials based on transparent oxides obtained according to said method, especially the transparent ceramic materials based on Y3A15012 (YAG) doped by lanthanides such as neodymium, and to the uses of said materials, especially for laser amplification.

The present invention relates to a new process for preparing transparent ceramic materials based on metallic oxides.

More particularly, the invention relates to the preparation of transparent ceramic materials based on a specific intermetallic oxide, namely the oxide Y₃Al₅O₁₂ doped with lanthanide cations (also depicted as “doped YAG” in the following description). The invention also concerns the doped YAG ceramics obtained in this context, which have been found to be particularly suitable as amplifying materials for laser cavities.

Usually, a ceramic material based on a metallic oxide is obtained from a mixture of particles (precursors), which are shaped (for example by molding, pressing or granulation), the shaped material being then densified, generally by heating in a furnace under a controlled atmosphere (this final step is commonly called “sintering”).

Among ceramic materials based on an oxide, transparent ceramic materials based on intermetallic oxides have been found to be particularly beneficial. These transparent materials have numerous fields of application, in particular in so far as they generally have beneficial properties other than their transparency. Depending on their properties, therefore, transparent ceramic materials based on intermetallic oxides have been found to be useful, in particular, for the construction of devices for optoelectronics (materials having ferroelectrical properties), scintillators (materials sensitive to X-rays and gamma rays), discharge lamp casings (highly refractory materials), protective visors (materials having very good mechanical properties), or jewelry or decorative components (materials having a high refractive index). Transparent ceramics based on intermetallic oxides also have optical applications. For all these applications, it is generally desirable for the ceramic material to have the highest possible homogeneity and transparency.

More specifically, some transparent ceramics based on an intermetallic oxide, such as YAG ceramics doped with neodymium, have recently been proposed for optical applications and, in particular, as an amplification medium in laser cavities. Doped YAG ceramics of this type aim to replace the monocrystals of doped YAG generally employed in solid lasers where a uniform distribution of the dopant (in particular neodymium) is not always easy to obtain and which also have the double drawback of being expensive and of being synthesizable only in the form of relatively small-sized rods (generally of at most about 20 cm in length by 2 cm in diameter).

In the aforementioned applications of transparent ceramics based on oxides, the ceramics should usually have excellent transparency. More specifically, it is generally desired that the properties of the ceramic material based on oxide are as similar as possible to those of a monocrystal of the corresponding oxide. This requirement is particularly pronounced in the case of transparent ceramics which are intended to be used as a laser amplification medium where behavior similar to that of a monocrystal is desired for obtaining an optimum yield.

So as to obtain a ceramic having properties similar to those of a monocrystal, this ceramic should generally be based on an oxide having a cubic crystallographic structure. The cubic system has structural isotropy which is manifested by an isotropic optical index. Consequently, even if the ceramic has differing crystalline domains (grains) oriented in a plurality of directions, the ceramic as a whole has the same isotropy of the optical index as a monocrystal would have.

In addition, to approach the properties of a monocrystal, it is desired that the ceramic has the lowest possible porosity and that it has the fewest possible defects (grain joints and domains of parasitic phases other than that of the desired oxide, in particular). For this purpose, for the synthesis of ceramics based on oxides of a plurality of metals or doped oxides (such as doped YAGs, in particular), it is also important that the differing metals present are distributed as uniformly as possible within the material obtained.

Numerous methods for synthesizing transparent ceramics based on intermetallic oxides have been developed in an attempt to achieve these objects. Thus, to obtain good homogeneity in the final ceramic material, it has been proposed, in particular, to use, as ceramic precursors, particles obtained by calcination of mixtures of oxides in the powdered state or, more advantageously, of precipitates obtained from inorganic salts.

Some of these methods lead to transparent ceramics based on intermetallic oxides having beneficial optical properties. For example, the method in the article by J. Lu et al. (J. Alloys and Comp., 341(1-2) p. 220 (2002), which leads to transparent ceramic materials of doped YAG which can be used as a laser amplification material, may be mentioned in this context. However, the degree of purity and homogeneity obtained with these methods is still unsatisfactory for some applications.

An object of the present invention is to provide a method for synthesizing transparent ceramics based on an intermetallic oxide leading to transparent ceramic materials having better qualities of transparency (in particular in terms of porosity and/or purity) and/or homogeneity than ceramics obtained by currently known methods.

To this end, according to a first aspect, the present invention provides a method for preparing a transparent ceramic material based on an intermetallic oxide, said method comprising the successive steps consisting in:

(A) synthesizing particles (p) based on said intermetallic oxide by calcination in an oxidizing atmosphere of particles (p₀) containing a homogeneous mixture of organic salts of the different metallic cations of the intermetallic oxide;

(B) from the particles (p) so obtained, producing a molded material (M) by compacting said particles (p), by a moist procedure, using the filtering pressing process; and

(C) thermally processing the molded material (M) so as to convert it, by sintering, into the sought transparent ceramic material.

The inventors' investigations have evidenced that this succession of steps (A) to (C) leads to transparent ceramic materials having excellent homogeneity also associated with reduced porosity and usually high purity which are manifested, in particular, by a smaller number of grain joints and parasitic phase domains other than the intermetallic oxide phases. These properties, which can cause the ceramic to behave in a manner very similar to that of a monocrystal, are particularly surprising in view of the results generally observed in prior art ceramics.

In the sense of the present description, “intermetallic oxide” denotes any metallic oxide comprising at least two different metals within its crystal lattice. Thus, an intermetallic oxide generally denotes:
a metallic oxide incorporating metallic cations of at least two different metals in its crystalline lattice (mixed oxide); or
a metallic oxide of at least a first metal also containing doping cations of at least one other metal as insertion and/or substitution cations.

The “material based on an intermetallic oxide” prepared according to the invention is a material which comprises such an intermetallic oxide, this oxide preferably being present within the material in a proportion of at least 80% by mass, advantageously at least 90% and still more preferably at least 95% by mass. According to a particularly advantageous embodiment, the transparent ceramic material based on an intermetallic oxide which is synthesized by the method of the invention substantially consists of said metallic oxide, (in other words usually comprises at least 98% by mass, advantageously at least 99% by mass, and still more preferably at least 99.5% by mass thereof).

This material is also a “transparent material”, which means, in the sense of the present description, that, for this material, there is at least one wavelength within the range of from 300 nm to 6,000 nm so that a laser beam having said wavelength and passing through the material has a ratio (luminous intensity after passing through the material/luminous intensity before passing through the material) of at least 90%, advantageously of at least 95%, more preferably of at least 99% and still more advantageously of at least 99.9%. The ratio of luminous intensity before and after passing through the material referred to here is that observed when a linearly polarized laser beam passes through the material inclined at the Brewster angle. At this angle, the effects of parasitic reflection on the faces of the material are non-existent, and this prevents optical losses due to Fresnel reflections.

The intermetallic oxide present in the transparent ceramic material prepared by the method of the invention is advantageously an oxide which crystallizes in the form of a cubic crystallographic structure, and is preferably an oxide from the sesquioxide or garnet family.

In a particularly advantageous manner, therefore, the intermetallic oxide forming the transparent ceramic material prepared by the method of the invention is selected from:
garnets of general formula C₃A₂D₃O₁₂, where O represents oxygen and where C, A and D represent metallic cations, generally in the +III state of oxidation, these cations being the same or different, it being however understood that the cations C and D being different from one another (the cations C, A and D generally occupy sites c, a and d respectively of the cubic spatial group Oₕ¹⁰-Ia3d). Examples of garnets of this type include, in particular, the oxides of formula Y₃Al₅O₁₂ (an oxide known as “YAG”) or else Gd₃Ga₅O₁₂ (“GGG”), Gd₃Sc₂Ga₃O₁₂ (“GSGG”), Yb₃Al₅O₁₂ (YbAG), Lu₃Al₅O₁₂ (“LuAG”), Er₃Al₅O₁₂ (“ErAG”), Y₃Sc₂Al₃O₁₂ (YSAG), containing or not containing doping cations, for example lanthanide doping cations or chromium doping cations (Cr³⁺ or Cr⁴⁺ ), usually as insertion and/or substitution cations; and
the sesquioxides of a first metal also containing doping cations of another metal such as, for example, Yb₂O₃, Y₂O₃ or Lu₂O₃ oxides, doped with metallic cations, especially with lanthanide cations.

In the most general case, whatever the exact nature of the intermetallic oxide, step (A) of the method of the invention consists in synthesizing particles (p) comprising an intermetallic oxide, by calcination in an oxidizing atmosphere (or “oxidizing calcination”) of particles (p₀) comprising a homogeneous mixture of organic salts.

This specific step affords a plurality of advantages.

First, it should be emphasized that the specific use of organic salts in the particles (p₀) leads to intermetallic oxide particles (p) of higher purity than those obtained by prior art methods, which employ calcination of precipitates obtained from inorganic salts (sulfates, chlorides, etc.). Contrary to inorganic salts, organic species are generally completely (or almost completely) eliminated during the thermal calcination treatment without leading to the formation of by-products which may be detrimental to the homogeneity and/or cohesion of the final ceramic material, nor inducing undesirable porosity.

Especially for obtaining particles of the highest possible purity, it is preferably that the particles (p₀) used in step (A) do not contain elements other than C, H and O and the metallic cations of the intermetallic oxide. To this end, the organic salts present in the particles (p₀) are advantageously carboxylates (for example acetates or lactates), or else acetylacetonates. In the particles (p₀) it is usually preferable to avoid the use of nitrogenous, phosphorus-containing, sulfurous or halogenated (in particular chlorinated) organic salts. More generally, it is preferable that the particles (p₀) do not contain any compound or element which might lead to the formation of a phase other than the desired intermetallic oxide in the particles (p), after the calcination step.

In step (A), the specific use of particles (p₀) based on a mixture of organic salts as a precursor of the particles (p) generally leads to particles (p) basically consisting of an intermetallic oxide which usually contain at least 98% by mass and typically at least 99% by mass of a single intermetallic oxide. Usually and more particularly if the particles (p₀) do not contain elements other than C, H and O and the metallic cations, the particles (p) obtained contain at least 99.5% by mass, or even at least 99.9% by mass of a single intermetallic oxide.

In addition, in step (A), the particles (p₀) used as precursors of the particles (p) comprise a homogeneous mixture of the organic salts of the metallic cations. In the context of the present description, the term “particles containing a homogeneous mixture of organic salts” refers to a population of particles in which each of the particles has a concentration of each of its constituents (in particular organic salts) which is substantially identical at any point of the particle (and advantageously identical at any point of the particle), the composition of the differing particles of the population generally being substantially identical (the composition of the differing particles usually all being identical).

This homogeneity in the composition of the particles (p₀) leads to a further significant advantage for the method of the invention: after the thermal treatment of step (A), a population of particles (p) is obtained, which each have a homogeneous composition and generally all have substantially the same overall composition. Without wishing to be bound to a particular theory, it seems plausible to assert that this homogeneity of the composition of the particles (b) explains, among other advantages, the excellent homogeneity of composition observed within the composition of the ceramic material eventually obtained.

All particles based on organic salts of cations of the intermetallic oxide which are to be synthesized can be used as particles (p₀) in step (A). In this context, however, it is usually found to be preferable to use particles (p₀) obtained by lyophilization of an aqueous solution comprising, in solution, the organic salts of the metallic cations of the intermetallic oxide which is to be obtained in the particles (p).

Thus, according to a specific advantageous embodiment, therefore, the particles (p₀) from step (A) of the method of the invention are obtained by a method comprising the steps consisting in:
(A1) producing an aqueous solution (S) containing, in solution, the organic salts of the metallic cations of the intermetallic oxide;
(A2) atomizing said aqueous solution (S) into liquid nitrogen to produce frozen particles having the homogeneous composition of the solution (S); and
(A3) allowing the frozen particles thus obtained under reduced pressure so as to remove the water contained in the frozen particles by sublimation from the solid state to the vapor state,
   whereby particles (p₀) containing a homogeneous mixture of the organic salts in the same proportions as in the solution (S) are obtained.

The particles (p₀) obtained by lyophilization, in particular in the aforementioned steps (A1) to (A3), are particles from which the water is particularly well eliminated. This substantial absence of water in the particles (p₀) limits the formation of aggregates during step (C), and this further improves the quality of the ultimately obtained material, in particular in terms of homogeneity and reduced porosity.

In step (A1) it should be understood that the proportions of the differing salts used should be adapted as a function of the intermetallic oxide to be obtained in the final ceramic material (and therefore in the particles (p)). On this subject, it should however be pointed out that it is extremely simple to determine these proportions in view of the specificity of the method. The method does not employ a precipitation step of the type envisaged in the prior art methods, and the proportions of the differing metals are consequently strictly the same in solution (S) and in the intermetallic oxide of the particles (p).

It is generally necessary to make use of a solution (S) having the lowest possible concentration in so far as, all other things being equal, a reduction in the concentration of the solution (S) induces a reduction in the size of the particles (p) obtained by the method of the invention, and this generally allows the homogeneity of the ultimately obtained ceramic material to be further improved and its porosity to be reduced. On this subject, it should be noted that the sizes of the particles (p) are advantageously less than 1,000 nm and more preferably less than 100 nm. For this purpose, it is generally preferable that, in the solution (S), each of the concentrations of the differing metallic cations present is less than 1 mol/l and advantageously less than 0.1 mol/l. In theory, there is no lower limit to the concentration of the solution (S), the quality of the ceramic obtained generally also being better, the lower this concentration. However, for economic reasons in particular it is generally preferable not to use an excessively low concentration for the solution (S), in particular to limit the production costs. In practice, therefore, the concentration of the majority of the metallic cations present in the solution (S) is typically between 0.001 and 1 mol/l and advantageously between 0.01 and 0.1 mol/l, and the concentration of some of the metallic cations present can be well below 0.001 mol/l (the concentration of cations intended to act as a dopant in the intermetallic oxide of the particles (p) can thus be well below 10⁻⁵ mol/l, for example between 10⁻⁹ and 10⁻⁶ mol/l).

It should be pointed out that the solution (S) contains the differing organic salts in solution. For this purpose, it may sometimes be necessary to adapt the pH of the solution (S), in particular to avoid precipitation phenomena between the differing salts present. To carry out such pH modulation, it is preferable to use organic species which advantageously do not contain elements other than C, H and O in order to modify the pH such as, for example, carboxylic acids (for example acetic acid if it is necessary to acidify the medium).

The particles (p₀) used in the method of the invention preferably have dimensions of between 0.1 μm (micron) and 10 μm, these dimensions preferably being less than 2 μm and typically between 0.5 μm and 1 μm.

To this end, the atomization in step (A2) is advantageously carried out by atomizing the aqueous solution (S) into liquid nitrogen contained, for example, in a vessel of the Dewar flask type. Atomization is preferably carried out using an atomizer comprising an atomization nozzle having a calibrated orifice, for example an orifice calibrated at 0.5 mm, through which the aqueous solution (S) is injected at a pressure of between 0.3 bar and 4 bar and typically at a pressure of approximately 3 bar, generally under the influence of a carrier gas which can be compressed air or an advantageously filtered neutral industrial gas such as argon or nitrogen. According to a beneficial embodiment, the solution (S) can be rotated within the atomization nozzle by means of a grooved conical insert. Owing to the centrifugal effect, a conical insert of this type allows the solution (S) to be placed against the internal wall of the nozzle before this solution is injected through the outlet orifice. A liquid jet in the form of an axial hollow cone with a turbulent effect is thus generally obtained.

Step (A3) is generally a conventional lyophilization step which can be carried out in any type of conventional lyophilizer. In this step, the conditions employed are not decisive as the particles are still preferably maintained in the frozen state until the water is eliminated, in particular to avoid interparticular agglomeration phenomena. It is moreover usually preferable that the conditions in step (A3) ultimately lead to substantial elimination of the water, in particular to avoid the creation of porosity within the particles during calcination of the particles (p₀) in step (A). For this purpose, step (A3) is advantageously carried out at a temperature of between −200° C. and +100° C., and more preferably between −20° C. and +50° C. and at a pressure of between 1 Pa and 100 Pa and more preferably at most 10 Pa. To enable lyophilization to take place effectively and as quickly as possible, therefore, it can be carried out, for example, at a temperature of approximately −20° C. and under a pressure of approximately 1 Pa.

The lyophilization step in step (A3) may advantageously be followed by a step of elimination of adsorbed water, usually while keeping the particles under the lyophilization pressure (typically at 1 Pa) and while raising the temperature, generally to at least 50° C., for example between 50 and 100° C.

Whatever the exact method used to prepare the particles (p₀), the calcination of these particles in step (A) is generally carried out under an atmosphere comprising oxygen, calcination usually taking place under a flow of an oxygen-containing hot gas such as a stream of oxygen or under an air stream, advantageously a filtered air stream. The temperature at which the oxidizing calcination of step (A) is carried out is generally between 900° C. and 1,500° C. In particular for effective conversion of the organic salts into an intermetallic oxide and perfect elimination of the organic compounds initially present in the particles (p₀), this calcination temperature is preferably at least 1,100° C. and more advantageously at least 1,150° C. However, it is preferable for this temperature to remain at at most 1,300° C. and preferably at most 1,250° C., in particular so as to reduce the size of the particles (p) obtained (all other things being equal, a reduction in the calcination temperature in step (A) generally induces a reduction in the size of the particles (p)). Thus the calcination in step (A) typically takes place at a temperature of between 1,100° C. and 1,300° C. and generally at a temperature of approximately 1,200° C.

The calcination in step (A) is carried out for a sufficiently long period to convert the mixture of organic salts of the particles (p₀) into the intermetallic oxide which is to be synthesized in the particles (p). The duration of calcination can vary to a fairly great extent depending on the exact nature of the composition of the particles (p₀) and the size thereof. In the majority of cases, however, this duration is approximately 1 to 5 hours, for example between 2 and 4 hours and typically approximately 3 hours.

According to a particular embodiment, in particular for further improving the homogeneity of the particles (p) and reducing the porosity thereof, the particles (p₀) can be subjected to a thermal pretreatment prior to the calcination in step (A). If necessary, this thermal pretreatment is advantageously carried out at a temperature of from 400° C. to 600° C. (typically at 500° C.), preferably under an air stream (advantageously filtered air). This embodiment also has economic advantages, in particular in so far as it allows the duration of the calcination step at elevated temperature to be limited.

The particles (p) obtained at the end of step (A), which can be used as a precursor of the ceramic material and are synthesized by the method of the invention, are particles based on intermetallic oxide which have specific properties, in particular excellent homogeneity. These specific particles constitute a further particular subject-matter of the present invention. In this context, the oxide-based particles such as Y₂O₃, Lu₂O₃ or YAG, doped with cations such as lanthanide cations, are found to be particularly beneficial, in particular as particles having luminophoric properties.

After step (A), the method of the invention comprises a step (B) of shaping the particles (p) in the form of a molded material (M). This step is carried out using a particular process of moist compaction of the particles (p) known as “filtering pressing”. The low porosity of the ceramic materials obtained seems to be explained at least in part by the specific implementation of this specific moist compacting process.

The “filtering pressing” process used in the method of the invention corresponds to a type of compaction which is well known from the prior art. Reference could be made, in particular, to the article by F. F. Lange (Journal of the American Ceramic Society, 72(1), pp. 3-15 (1989)) for further details on this subject.

In the context of the method of the invention, the filtering pressing in step (B) advantageously comprises the successive steps consisting in:

(B1) suspending the particles (p) in a polar solvent (preferably water and/or ethanol and preferably water), without using a dispersant; and

(B2) introducing the suspension of particles (p) thus obtained into a mold equipped with:
(i) pressing means; and
(ii) an outlet equipped with filtration means capable of selectively retaining the particles (p) and allowing the passage of water; and

(B3) compressing the medium introduced into the mold using pressing means to produce the egress of water from the mold and compaction of the particles (b) in the form of a compacted molded material.

In the aforementioned step (B1), the polar solvent in which the particles (p) are suspended is advantageously water, ethanol or a water/ethanol mixture, this solvent preferably being water. As a general rule, the suspending in step (B1) is carried out with a mass ratio (particles (p)/solvent) of between 5% and 70%. Without wishing to be bound to a particular theory, the inventors' investigations seem to show that this ratio (particles (p)/solvent) is a parameter which influences the qualities of transparency of the synthesized ceramic material. In particular, this parameter influences the porosity of the material obtained. Generally, to obtain the lowest possible porosity, the mass ratio (particles (p)/solvent) is advantageously at least 10%, preferably at least 15%, and it preferably remains at at most 50% and advantageously at most 35%. Thus, to obtain optimum porosity properties, this mass ratio should usually be between 18 and 25% (typically, this ratio is approximately 21%).

It should be noted that step (B1) is carried out without using a dispersant, and this obviates the need for a subsequent purification which would otherwise be necessary. To disperse the particles (p) in step (B1) in the absence of dispersants, this dispersion is advantageously produced by introducing the particles (p) obtained at the end of step (A) into the polar solvent (generally water) and subjecting the medium obtained to mechanical disintegration with stirring, generally in the presence of beads, optionally with stirring carried out for a duration of from 12 to 48 hours and typically for a duration of approximately 20 hours.

The mold used in step (B2) may be a mold of the type conventionally used in the filtering pressing process. Thus, for example, this mold can be a commercial pelletizing mold, for example of the SPECAC type (typically a 20 mm diameter SPECAC pelletizing mold made of stainless steel).

With regard to step (B3), the pressure applied for carrying out compression is usually between 50 MPa and 350 MPa. In particular to optimize the porosity of the ultimately obtained ceramic material, this pressure is preferably between 150 MPa and 250 MPa, and it can thus typically be approximately 200 MPa.

In step (B), the particles (p) may be used as sole particles in the moist compaction method.

According to a further beneficial embodiment, the particles (p) are compacted together with other particles (p′) in step (B). In this case, step (B) can be carried out under the aforementioned conditions, advantageously by employing the succession of steps (B1) to (B3), the particles (p′) being suspended together with the particles (p) in step (B1) (the particles (p′) generally being mixed with the particles (p) prior to step (B)). In this case, it is preferable that the mass ratio (p′)/(p) is between 0.05% and 5%, this ratio advantageously being less than 1%. In step (B1), the mass ratio (particles (p)+(p′))/solvent is thus advantageously at least 10% and preferably remains at most 50%, this ratio advantageously being between 15 and 35% (typically, this ratio is approximately 21%).

According to a particular embodiment, therefore, step (B) is carried out with the additional presence of particles (p′) based on silica SiO₂. These silica-based particles (p′) enable, in particular, the porosity of the ceramic material obtained after the method to be reduced by allowing, in particular, an improvement in the densification of the material during step (C). In the case of silica-based particles (p′), the mass ratio (p′)/(p) is thus advantageously between 0.05% and 1%.

The method of the invention finally comprises a step (C) of sintering the molded material (M) obtained in step (B). This step generally consists in thermally treating the molded material (M) under an atmosphere of a controlled nature and pressure.

According to a particular embodiment, the method of the invention can comprise a step of isostatic compression after step (B) and prior to step (C), in particular to complete the densification thereof prior to sintering. If necessary, this isostatic compression (a step also known as “isostatic pressing”) is usually carried out under conventional conditions known to a person skilled in the art. Isostatic pressing is a process known per se and used, in particular, for producing shaped parts, for example for the production of large shaped parts.

The sintering in step (C) can employ any type of sintering conventionally employed in methods for synthesizing ceramics based on metallic oxides such as, for example, sintering under reduced pressure of the type described, for example, in the Journal of the American Ceramic Society, 78(4), pp. 1033-1040 (1995) or sintering under load, for example sintering under isostatic compression as described in the Journal of the American Ceramic Society, 79(7), pp. 1927-1933 (1996).

Advantageously, step (C) is carried out at a temperature of between 1,500° C. and 1,800° C., preferably between 1,650° C. and 1,750° C. (for example between 1,700 and 1,750° C.), and preferably under a pressure of between 10⁻⁴ Pa and 10 Pa (typically under a pressure of approximately 1.3 Pa). Generally, step (C) is carried out for a duration of from 1 to 24 hours, typically approximately from 2 to 4 hours, for example for 3 hours.

According to a particular embodiment, the method of the present invention can be used to prepare a transparent ceramic material based on YAG (Y₃Al₅O₁₂) doped with at least one metal M from the lanthanide family.

According to this particular embodiment, step (A) of the method consists in synthesizing particles (p) based on Y₃Al₅O₁₂ doped with said metal M by calcination in an oxidizing atmosphere of particles (p₀) comprising a homogeneous mixture of organic salts of Y³⁺, Al³⁺ and M³⁺, this mixture preferably not containing any elements other than Y, Al, M, C, H and O.

The term “lanthanide” in the context of the present description refers to an element between lanthanum and lutetium in the periodic table of elements, namely an element of which the atomic number is between 57 and 71, inclusive.

Beneficial doped YAG ceramic materials which can be synthesized by the method of the invention include, in particular, materials in which the metal M is selected from neodymium (Nd), praseodymium (Pr), cerium (Ce), erbium (Er), holmium (Ho), dysprosium (Dy), samarium (Sm), thulium (Tm), ytterbium (Yb) and Europium (Eu).

In particular, the process of the invention allows the synthesis of transparent ceramic materials based on YAG doped with neodymium Nd.

In general, if a transparent ceramic material based on YAG doped with a metal M from the lanthanide family is to be synthesized by the method of the invention, steps (A) to (C) can be carried out under the aforementioned conditions, which can be employed in the most general case.

For the specific preparation of doped YAG particles, however, the following specificities should be pointed out.

For the preparation of a transparent ceramic material based on YAG doped with a lanthanide M, the particles (p₀) from step (A) are advantageously obtained by lyophilization of a homogeneous aqueous solution (SYAG) comprising organic salts of Y³⁺, Al³⁺ and M³⁺, this solution preferably not containing any elements other than Y, Al, M, C, H and O.

As in the general case, this lyophilization advantageously comprises the steps consisting in

(a1) producing an aqueous solution (S_{YAG}) containing, in solution, the organic salts of Y³⁺, Al³⁺ and M³⁺;

(a2) atomizing said aqueous solution (S_{YAG}) into liquid nitrogen to produce solidified particles having the homogeneous composition of the solution (S_{YAG}); and

(a3) leaving the frozen particles thus obtained under reduced pressure so as to remove the water contained in the frozen particles by sublimation from the solid state to the vapor state,

whereby particles (p₀) containing a homogeneous mixture of the organic salts of Y³⁺, Al³⁺ and M³⁺ in the same proportions as in the solution (S_{YAG}) are obtained.

Steps (a1) to (a3) are advantageously carried out under the preferred conditions of steps (A1) to (A3) defined in the general case.

More specifically, it should be pointed out that the solution (S_{YAG}) used advantageously consists of an aqueous mixture of yttrium acetate, aluminum lactate and neodymium acetate, to which acetic acid is added so that the pH of said aqueous mixture is of less than or equal to 4. The obtaining of a pH of at most 4 prevents the formation of an yttrium lactate precipitate in the solution and therefore enables the homogeneity thereof to be maintained.

Alternatively, the solution (S_{YAG}) can also consist of a mixture of yttrium oxide, neodymium oxide and aluminum lactate dissolved in an aqueous acetic acid solution in such a way that the pH of said solution is of less than or equal to 4.

Whatever the exact nature of the solution (S_{YAG}) it must generally comprise the metallic cations Y³⁺, Al³⁺ and M³⁺ dispersed homogeneously within the solution.

In the solution (S_{YAG}), the sum of concentrations of cations Y³⁺ and M³⁺ is preferably less than 1 mol/l, for example between 0.001 and 0.1 mol/l. The concentration of cations Al³⁺ for its part is usually less than 1 mol/l, typically between 0.001 and 0.1 mol/l.

In addition, in the solution (S_{YAG}), the molar ratio (Y³⁺+M³⁺)/Al³⁺ should generally be between 0.59:1 and 0.61:1, this ratio typically being approximately 3:5. The molar ratio (Y³⁺+M³⁺)/Al³⁺ in the solution (S_{YAG}) is more preferably between 0.597:1 and 0.603:1, and advantageously between 0.599:1 and 0.601:1, in particular when the synthesized ceramic material based on doped YAG is intended for an application as a laser amplification material.

On the other hand, in the solution (S_{YAG}), the molar ratio M³⁺/(Y³⁺+M³⁺) is that which is desired in the ultimately obtained doped YAG ceramic material. This ratio is generally between 0.01 and 99.9%, this molar ratio M³⁺/(Y³⁺+M³⁺) usually being less than 10% and generally 8%. Thus, this ratio is typically between 0.01% and 6%, for example between 0.1 and 5%, particularly if the ceramic material is intended to be used as an amplifying material for laser cavities, but this ratio can be adapted as a function of the envisaged applications for the synthesized ceramic.

In view of the nature of steps (a1) to (a3), the values of the above-mentioned differing ratios are identical in the solution (S_{YAG}) and in the particles (p₀) obtained after step (a3).

Generally, particles (p₀) as obtained after step (a3) are immediately subjected to oxidizing calcination in step (A). Storage of the particles (p₀) obtained after step (a3) prior to the calcination thereof in step (A) is not however ruled out, if necessary. It will be appreciated that the particles (p₀) will advantageously be stored in the absence of moisture.

The particles (p) based on YAG (Y₃Al₅O₁₂) doped with said metal M from the lanthanide family obtained after step (A) represent a specific subject of the present invention.

For the specific preparation of a transparent ceramic material based on YAG doped with a lanthanide M, steps (B) and (C) of the method of the invention are generally carried out under the same conditions as in the general case.

As pointed out above in the present description, the succession of steps (A) to (C) of the method of the invention leads to the obtaining of transparent molded ceramic materials having noteworthy qualities, in particular very high homogeneity of composition, extremely low porosity and very high purity. This result is observed in all cases, whether the method is used to prepare ceramics based on doped YAG or based on other intermetallic oxides. According to a further feature, the transparent molded ceramic materials based on an intermetallic oxide obtainable by the method of the present invention, which have the aforementioned advantages, represent a particular subject of the present invention.

In this context, the present invention relates in particular to the transparent molded ceramic materials based on YAG doped with a metal M from the lanthanide family and, in particular, the transparent molded ceramic materials made of YAG doped with neodymium obtainable by the method of the invention.

Finally, according to a final feature, the present invention relates to the differing uses of the materials obtained by the method of the invention.

Generally, a transparent molded ceramic material obtained by the present invention can be used as a material for the conventional applications of ceramics based on intermetallic oxides where their properties of transparency and homogeneity enable them, often in a very advantageous manner, to replace the currently known ceramics based on intermetallic oxides. The ceramic materials obtained by the method of the invention can also be used as materials for scintillators.

According to more specific embodiments, some ceramic materials obtained according to the invention such as YAG-based ceramics can be used in the crushed state, in other words reduced to a powder by means of abrasives. Some other materials, in particular based on Y₂O₃, YAG or Lu₂O₃ doped with cations such as lanthanide cations, can be used as luminophoric materials, these materials thus advantageously being reduced to submicronic particles.

More specifically, in view of their qualities of homogeneity, low porosity and purity, by means of which their behavior usually approximates that of a monocrystal, the transparent molded ceramic materials based on an intermetallic oxide obtained by the method of the present invention can be used in optical applications, for example for preparing lenses having a defined optical index. More specifically, some of the intermetallic oxides obtained by the method of the present invention can be used as an amplifying material for laser cavities, in particular for lasers for engraving semiconductors, for telemetry, surgery or machining. This is the case, in particular, with ceramic materials obtained according to the invention which are based on YAG doped with a metal M from the lanthanide family, preferably with neodymium (Nd), and which are particularly useful as amplifying materials for a laser cavity.

Although it is described in greater detail for the preparation of ceramic materials based on doped YAG, the present invention can be used for the preparation of any other intermetallic oxide by adapting the nature of the organic salts used and the proportions between the differing cations. Thus, for example, the succession of steps (A) to (C) of the method of the invention can be used to prepare lutetium-based intermetallic oxides by using lutetium acetate (or lutetium oxide dissolved in acetic acid) as the organic salt in the particles (p₀) of step (A).

Similarly, this method can be used to synthesize ceramics from ytterbium-based oxides using ytterbium acetate (or ytterbium oxide dissolved in acetic acid) as the organic salt in the particles (p₀).

Some characteristics and advantages of the invention will emerge more explicitly on reading the following illustrative example.

### EXAMPLE

Preparation of a transparent molded ceramic material based on YAG doped with neodymium

(a) Synthesis of doped YAG particles

Step 1: Synthesis of Particles Based on a Homogeneous Mixture of Organic Salts of Yttrium, Aluminum and Neodymium

1.1 Preparation of an Aqueous Solution of Yttrium, Aluminum and Neodymium Salts 8.32 g of aluminum lactate (Prolabo Rectapur 98%), 15.74 g of yttrium acetate (Chempur 99% ) and 0.102 g of neodymium acetate (Aldrich 99.9%) were introduced into 600 ml of deionized water brought to boiling point.

To prevent precipitation of the yttrium cations in the form of yttrium lactate in the medium produced, 115 g of acetic acid were added so as to keep the pH of the medium at a value of at most 4. A clear solution of the yttrium, aluminum and neodymium salts having a pH of 3.5 after complete dissolution of the salts was thus obtained.

1.2 Solidification of the Solution in the Form of Particles Frozen by Atomization into Liquid Nitrogen

The clear solution obtained in the foregoing step 1.1 was atomized into liquid nitrogen (contained in a Dewar flask) so as to bring about instantaneous solidification of the atomized droplets.

The solution was atomized into liquid nitrogen using an atomizer consisting of a reservoir connected at its top to a carrier gas (compressed air) inlet and at its bottom to an atomization nozzle having an orifice of 0.5 mm through which the solution was injected under a pressure of 3 bar. The nozzle used also contains a grooved conical insert for rotating the liquid in the nozzle and, due to the centrifugal effect, this places the liquid against the internal wall of the nozzle prior to the ejection thereof through the outlet orifice, by means of which a jet of liquid is obtained at the outlet of the atomizer in droplets of approximately 1 μm having the form of an axial hollow cone with a turbulent effect.

1.3 Lyophilization of the Particles

The solidified particles obtained after step 1.2 were introduced into a commercial lyophilizer (alfa 2-4 lyophilizer (Christ)) at the temperature of the liquid nitrogen.

The pressure in the lyophilizer chamber was reduced to 1 Pa, and the lyophilizer chamber was kept under this low pressure and at −20° C. for 20 hours.

The chamber was then brought to +50° C. while maintaining the pressure at 1 Pa. The medium was kept at +50° C. under 1 Pa for 3 hours.

This maintenance under reduced pressure at −20° C. for 20 hours and at +50° C. for 3 hours causes elimination of the water by sublimation then desorption, as a result of which 16 g of particles in the form of a dry powder are obtained after this treatment.

Step 2: Heat Treatment of the Particles Under an Oxidizing Atmosphere

2.1 Heat Treatment Under Air Atmosphere

The dry powder obtained after step 1.3 was calcined in a tubular furnace in air at 500° C. for 30 minutes. This heat treatment allows the majority of the organic compounds present in the particles to be eliminated.

2.2 Oxidizing Calcination Under Oxygen

Subsequent to the heat treatment in the preceding step, the particles obtained were treated under a stream of oxygen at 1,100° C. for a duration of 3 hours. The flow rate of the oxygen stream at 1,100° C. used is 0.5 liters per minute. After this heat treatment, perfectly oxidized particles based on YAG doped with neodymium were obtained in the form of a powder which can be stored as it is in a vacuum desiccator.

(b) Shaping: Preparation of a Molded Material From Particles of Doped YAG (Filtering Pressing Process)

Production of an Aqueous Suspension of the YAG Particles

The doped YAG particles obtained after step (a) were suspended in deionized water in the presence of colloidal silica (99.98% alfa silica).

Suspending was carried out by introducing into a bottle:
1.5 g of particles as obtained after step (a);
7 ml of deionized water;
13.5 mg of silica particles; and
1 g of yttriated zirconium beads, 3 mm in diameter (Glenmills).

The bottle was then hermetically sealed and the medium was agitated for 12 hours.

After agitation, an aqueous suspension of the doped YAG particles and silica particles was recovered.

Filtering Pressing

The suspension obtained was poured into a pelletizing mold of the SPECAC type made of stainless steel (20 mm diameter).

Filtering pressing was carried out within this mold by subjecting the internal medium to an excess pressure, and this has the effect of expelling the water to the exterior, the particles being retained in the interior. Filtering pressing was carried out by applying a pressure of 300 MPa for a duration of 10 minutes.

After this treatment, a pellet was obtained resulting from compaction of the doped YAG and silica particles from the suspension introduced into the mold.

The pellet obtained was then subjected to a step of isostatic pressing, in particular to complete the crude densification thereof (10 minutes of pressing at 200 MPa).

(c) Sintering of the Molded Material by Heat Treatment Under Reduced Pressure

The pellet obtained after the step of isostatic pressing was subjected to a sintering heat treatment carried out at 1,700° C. in a furnace kept under a reduced pressure of 10⁻³ Pa.

This heat treatment was carried out by progressively bringing the temperature of the pellet from ambient temperature (20° C.) to 1,700° C. with a gradient of rise in temperature of 10° C. per minute. The pellet was then maintained at 1,700° C. in the furnace for 1 hour. The temperature of the medium was then progressively reduced from 1,700° C. to ambient temperature (about 20° C.) with a gradient of descent in temperature of 10° C. per minute.

A transparent polycrystalline doped YAG ceramic was obtained after these treatments steps.

1-35. (canceled)

36. A method for preparing a transparent ceramic material based on an intermetallic oxide, said method comprising the successive steps consisting in:
(A) synthesizing particles (p) based on said intermetallic oxide, by calcination in an oxidizing atmosphere of particles (p₀) containing a homogeneous mixture of organic salts of the different metallic cations of the intermetallic oxide;
(B) from the so-obtained particles (p), producing a molded material (M) by compacting said particles (p), by a moist procedure, using the filtering pressing process; and
(C) thermally processing the molded material (M) so as to convert it, by sintering, into the sought transparent ceramic material.

37. The method of claim 36, wherein the particles (p₀) used in step (A) are particles obtained by lyophilization of an aqueous solution comprising, in a solubilized state, the salts of the metallic cations of the intermetallic oxide.

38. The method of claim 36, wherein said intermetallic oxide is selected from:
the garnets of general formula C₃A₂D₃O₁₂, in which C, A and D represent metallic cations, which may be the same or different, it being understood that the cations C and D are different from one another;
the garnets of the aforesaid formula C₃A₂D₃O₁₂, which further contain doping cations;
the sesquioxides of a first metal, further containing doping cations of another metal.

39. The method as claimed in claim 38, wherein the intermetallic oxide is selected from:
the garnets of formula Y₃Al₅O₁₂, Gd₃Ga₅O₁₂, Gd₃Sc₂Ga₃O₁₂, Yb₃Al₅O₁₂, Lu₃Al₅O₁₂, Er₃Al₅O₁₂ and Y₃Sc₂Al₃O₁₂, these garnets containing or not containing doping cations, and
the sesquioxides of formula Yb₂O₃, Y₂O₃ and Lu₂O₃, these sesquioxides containing doping cations.

40. The method of claim 36, wherein the particles (p₀) used in step (A) contain no elements other than C, H and O and the metallic cations of the intermetallic oxide.

41. The method of claims 36, wherein the particles (p₀) have dimensions of between 0.1 μm and 10 μm.

42. The method of claim 36, wherein the particles (p₀) used in step (A) are obtained by a method comprising the steps consisting in:
(A1) producing an aqueous solution (S) containing, in solution, the organic salts of the metallic cations of the intermetallic oxide;
(A2) atomizing said aqueous solution (S) into liquid nitrogen to produce solidified particles having the homogeneous composition of the solution (S); and
(A3) leaving the frozen particles thus obtained under reduced pressure so as to remove the water contained in the frozen particles by sublimation from the solid state to the vapor state,
whereby particles (p₀) containing a homogeneous mixture of the organic salts in the same proportions as in the solution (S) are obtained.

43. The method of claim 42, wherein each of the concentrations in the differing metallic cations present is less than 1 mol/l in the solution (S).

44. The method of claim 36, wherein the calcination of the particles (p₀) is carried out in step (A) under an oxygen-containing gas flow at a temperature of between 900° C. and 1500° C.

45. The method OF claim 44, wherein the particles (p₀) are subjected to a thermal pre-treatment prior to the calcination in step (A), at a temperature of 400° C. to 600° C.

46. The method of claim 36, wherein the filtering pressing in step (B) comprises the successive steps consisting in:
(B1) suspending the particles (p) in a polar solvent, without using a dispersant; and
(B2) introducing the suspension of particles (p) thus obtained into a mold equipped with:
(i) pressing means; and
(ii) an outlet equipped with filtration means capable of selectively retaining the particles (p) and allowing the passage of water; and
(B3) compressing the medium introduced into the mold using pressing means to discharge water from the mold and compact the particles (b) into a compacted molded material.

47. The method OF claim 46, wherein the polar solvent in which the particles (p) are suspended in step (B1) is water, ethanol, or a water/ethanol mixture.

48. The method of claim 46, wherein the mass ratio (particles (p)/water) in step (B1) is between 5% and 70%, preferably between 10% and 50%.

49. The method of claim 46, wherein the particles (p) from step (B1) are dispersed by introducing the particles (p) into the polar solvent and subjecting the medium obtained to mechanical disintegration with stirring.

50. The method of claim 46, wherein the pressure applied to carry out the compression in step (B3) is between 50 MPa and 350 MPa.

51. The method of claim 45, wherein the particles (p) are used as single particles in the moist compacting process in step (B).

52. The method of claim 45, wherein the particles (p) are compacted together with other particles (p′) in step (B).

53. The method of claim 52, wherein the mass ratio (p′)/(p) is between 0.05% and 5%.

54. The method of claim 36, wherein it comprises a step of isostatic compression following step (B), prior to step (C).

55. The method of claim 36, wherein step (C) is carried out at a temperature of between 1500° C. and 1800° C. under a pressure of between 10⁻⁴ Pa and 10 Pa.

56. The method of claim 36, wherein the prepared material is a transparent ceramic material based on Y₃Al₅O₁₂ (YAG) doped with at least one metal M from the lanthanide family, in which step (A) of the method consists in synthesizing particles (b) based on YAG doped with said metal M by calcination in an oxidizing atmosphere of the particles (p₀) comprising a homogeneous mixture of organic salts of Y³⁺, Al³⁺ and M³⁺.

57. The method of claim 56, wherein the metal M is selected from the group consisting in neodymium (Nd), praseodymium (Pr), cerium (Ce), erbium (Er), holmium (Ho), dysprosium (Dy), samarium (Sm), thulium (Tm), ytterbium (Yb) and Europium (Eu).

58. The method of claim 57, wherein the metal M is neodymium (Nd).

59. The method of claim 55, wherein the particles (p₀) of step (A) are obtained by lyophilization of a homogeneous aqueous solution (S_{YAG}) comprising organic salts of Y³⁺, Al³⁺ and M³⁺, this lyophilization comprising the steps consisting in:
(a1) producing the aqueous solution (S_{YAG}) containing, in solution, the organic salts of Y³⁺, Al³⁺ and M³⁺;
(a2) atomizing said aqueous solution (S_{YAG}) into liquid nitrogen to produce solidified particles having the homogeneous composition of the solution (S_{YAG}); and
(a3) leaving the frozen particles thus obtained under reduced pressure so as to remove the water contained in the frozen particles by sublimation from the solid state to the vapor state,
whereby particles (p₀) containing a homogeneous mixture of the organic salts of Y³⁺, Al³⁺ and M³⁺ in the same proportions as in the solution (S_{YAG}) are obtained.

60. The method of claim 59, wherein the solution (S_{YAG}) is:
an aqueous mixture of yttrium acetate, aluminum lactate and neodymium acetate, to which acetic acid is added so that the pH of said aqueous mixture is of less than or equal to 4; or
a mixture of yttrium oxide, neodymium oxide and aluminum lactate dissolved in an aqueous acetic acid solution so that the pH of said solution is of less or equal to 4.

61. The method of claim 59, wherein the sum of the concentrations of cations Y³⁺ and M³⁺ is less than 1 mol/l in the solution (S_{YAG}) and wherein the concentration of cations Al³⁺ is of less than 1 mol/l.

62. The method of claim 59, wherein the molar ratio (Y³⁺ +M³⁺)/Al³⁺ is between 0.59:1 and 0.6:1, preferably between 0.597:1 and 0.603:1 in the solution (S_{YAG}), and wherein the molar ratio M³⁺/(Y³⁺+M³) is between 0.01% and 99.9%.

63. A transparent molded ceramic material based on intermetallic oxide, as obtained by the method as claimed in claim 36.

64. A transparent molded ceramic material based on Y₃Al₅O₁₂ (YAG) doped with a metal M from the lanthanide family, as obtained according to claim 58.

65. A material according to claim 64, wherein the metal M is neodymium.

66. A method making use of a material of claim 64 as an amplifying material for a laser cavity.

67. The particles based on intermetallic oxide as obtained at the end of step (A) of the method of claim 36.

68. The particles, as obtained at the end of the succession of steps (A1), (A2) and (A3) as defined in claim 42.

69. The particles based on Y₃Al₅O₁₂ (YAG) doped with a metal M from the lanthanide family, as obtained at the end of step (A) of the method of claim 57.

70. The particles of claim 69, wherein the metal M is neodymium.
